(19) United States
(12) Patent Application Publication
(10) Pub. No.: US 2018/0287790 A1
(43) Pub. Date: Oct. 4, 2018

(54) AUTHENTICATION OF A TRANSFERABLE VALUE OR RIGHTS TOKEN

(71) Applicant: Tibado Limited, Littlehampton, West Sussex (GB)

(72) Inventors: David Everett, Rustington, West Sussex (GB); Timothy Jones, Brighton, East Sussex (GB); John Owen, Worthing, West Essex (GB)

(21) Appl. No.: 15/766,227

(22) PCT Filed: Oct. 5, 2016
(86) PCT No.: PCT/IB2016/001446

§ 371 Date: Apr. 5, 2018

(30) Foreign Application Priority Data
Oct. 6, 2015 (GB) 1517581.3

(51) Int. Cl. H04L 9/08; H04L 29/06; H04L 9/32

(52) U.S. Cl. CPC H04L 9/0861; H04L 2209/56; H04L 9/3239; H04L 63/0823

(57) ABSTRACT

A transferable value or rights system where the value or rights can be passed from entity to entity as required and is protected by a validation database that enables validation of the current state of both pockets and unspent tokens or coins.

### FIELD OF INVENTION

This invention relates to secure electronic communications, and more particularly to authentication of a transferable value or rights token using a validation database.

### BACKGROUND

Tokens can be used to represent the value of an asset or a right to a service. Such value or rights may relate to a representation of any physical or digital asset including for example digital currencies, stocks, shares, coupons, bonds, options, vouchers, deeds etc.

Referring to FIG. 1, there is shown a transferable value or rights system 2 in accordance with Applicants patent publication GB 1417413.0, the entire content of which is hereby incorporated herein by reference. The illustrated system comprises a user access device 4 which includes a user interface 6 and an authentication module 8A which connects to a communication media 10 to obtain access to a pocket controller 12. This pocket controller 12 includes a memory configured to store at least two pockets 14 which store the current balance of the value or rights held by a respective user. The users gain access to their pocket(s) through the controller 16 after successful authentication by the authentication component 8B. The controller 16 connects to a certification engine 18 to create one or more digital signatures or cryptographic check values that are used to protect tokens. Issued tokens are stored in a Token store 20. Tokens can be stored and moved in any suitable form including for example by the use of bar codes.

The pocket controller 12 provides at least two core functions to the users, the ability to create tokens and the ability to load tokens. Once a token is created it does not need to contain any reference to the source pocket from which the token was created or the pocket into which the token will eventually be loaded. In this sense the token is anonymous because it contains no reference to the users of the system.

The system of Applicants patent publication GB 1417413.0 is based on the concept of creating anonymous tokens (or “coins”) of a user-defined value that can be readily transferred between users in a way that more closely relates to the handling of cash, but in an on-line mode. Although the handling of tokens is assumed to be through on-line communications media it is possible to define an embodiment where only the receiver of the token needs to be on-line.

Users of the system may enroll in order to be assigned a pocket and receive credentials to enable their access to be authenticated. User access authentication may be the traditional user name and password or a 2-Factor authentication method using something the user owns such as a smart card and something the user knows such as a password. In some cases, the system may use the Transport Layer Security (TLS) protocol where the user is issued with a client certificate to store in devices such as mobile phones and tablets or PCs. The users may arbitrarily enhance this security by requiring further access credentials to use the client certificate such as a user PIN or password.

When a user wishes to transfer a value token to another party, the user connects to the authentication module 8B of the pocket controller 12. Based on the credentials provided by the user authentication process, the controller 16 identifies which pocket belongs to the user making the authentication request.

Following successful authentication, the user may then request the creation of a value token. The controller 16 will then decrement the user's pocket and create a corresponding value token. This value token may be protected by a cryptographic check sum, although a digital signature would be an alternative security technique.

In normal operation the controller 16 would actually create two cryptographic checksums using two separate security domains. This provides a more secure approach particularly where access to the token controller takes place over the internet. The two security domains may be located and managed by different legal entities such that, in practice, collusion to make an attack is extremely difficult to achieve and hence highly unlikely.

For the purposes of this disclosure, the term “security domain” shall be understood to refer to run-time environment in which messages may be secured by means cryptographic keys, checksums and/or digital signatures generated using of a set of one or more certificates and/or root keys that are typically provided by a trusted authority. A security domain may comprise a respective Certification Authority (CA) for keys issued within that security domain, and respective cryptographic features (including algorithms), either of which may be the same or different from those of other security domains. The term “separate security domains” refers to run-time environments in which messages may be secured on the basis of respective different sets of certificates and/or root keys, and possibly respective different CAs. In some cases, the certificates and/or root keys defining two or more separate security domains may be provided by respective different trusted authorities, but this is not essential. Typically, messages secured under one security domain cannot be validated by a process using a different security domain. Applicants' patent publication GB 1417413.0 teaches embodiments in which each token is secured by cryptographic check sums generated using two separate security domains. This means that in order to attack the token, it would be necessary for a hacker to obtain both sets of certificates and/or root keys.

The two cryptographic checksums enable the token transfer process to consist of three steps, the creation of a token by a “sending” party, and the load of a token by a receiving party, which has two steps. In a first step, the receiving party is given the token and just one of the two cryptographic checksums. This enables the controller 16 to check the authenticity of the token and to mark its destination to be that of the receiving party's pocket. In the second step, the receiving party is given the second cryptographic checksum, which they can present to the controller 16 in order to vest the value of the token in their pocket. This certificate verification technique allows the transaction process to take place in two steps but allows the receiving party to ensure that they have received an authentic token and that it cannot be spent by anybody else.

This type of operation is particularly useful when the two parties engaged in a transaction do not trust each other. On the other hand, in many cases the sender and receiver would trust each other. In such a case, perhaps for example when a parent is paying value to their children, it would not be necessary to split the load and verify function. Rather, the receiving party could be given both cryptographic check sums in a single operation, so that they can present both cryptographic check sums along with the token to the controller, again as a single operation.

The value transfer system also allows an additional function for users to check the validity of the value token by providing a validate operation. In this case the receiver of the token can send it to the controller 16 to request a validity check. The controller 16 would check that the token is authentic and has not previously been spent. In this case the receiver may not have all the information necessary to load the token, for example the sender may not have provided the second (i.e. the verification) cryptographic check sum. However, the token can still be marked as unspent and could be given to another user. The load command results in the token being marked as spent even though the value may not be vested with the receiver, who is still awaiting the verification cryptographic check sum.

It is an important to recognise that it is not necessary to include information in the token that identifies either the sender or the receiver. Breaking the link between tokens and user identities in this way means that the spending behaviour of users cannot be monitored and their activities can be truly anonymous. This may be important not only when the tokens are used for payments but also when they relate to rights, such as for example a vote.

How the users of the system handle the security of the tokens is arbitrarily their choice. The tokens are protected by their own integrity function and it is not possible for an attacker to modify the contents of the token without detection. The creation and processing of tokens to decrement value from the sender's pocket and load value to the receiver's pocket is exclusively handled by the controller 16, which can therefore operate to guarantee the integrity of the system. However, this means that a pocket is actually managed by the controller 16, rather than the owner of the value recorded in that pocket. In some cases, it would be preferable for the users to be able to look after their own pockets of value or rights. This gives rise to a problem to be solved, which may be described as how to ensure security and integrity of the system when each user is responsible for managing their own pocket(s).

### SUMMARY

The above noted problem is solved by the combination of features defined in the appended independent claims. Further, optional features of the invention are defined in the appended dependent claims.

An advantage of the present invention is that it offers the users of the system the ability to manage their own pockets, while enabling the token handler to ensure the security and integrity of the system as a whole.

### BRIEF DESCRIPTION OF DRAWINGS

Further features and advantages of the present invention will become apparent from the following detailed description, taken in combination with the appended drawings, in which:

FIG. 1 is a block diagram schematically illustrating principal components of a transferable value or rights token system in accordance with known techniques, where the term “Tibado” represents a Token Handler;

FIG. 2 is a block diagram schematically illustrating principal components of a transferable value or rights token system in accordance with an embodiment of the present invention, where the term “Tibado” represents a Token Handler;

FIGS. 3A and 3B are sequence diagrams that shows a representative transfer of value token in accordance with an embodiment of the present invention; and

FIG. 4 is a sequence diagram that shows a representative process for reloading a token value to its source pocket, in accordance with an embodiment of the present invention.

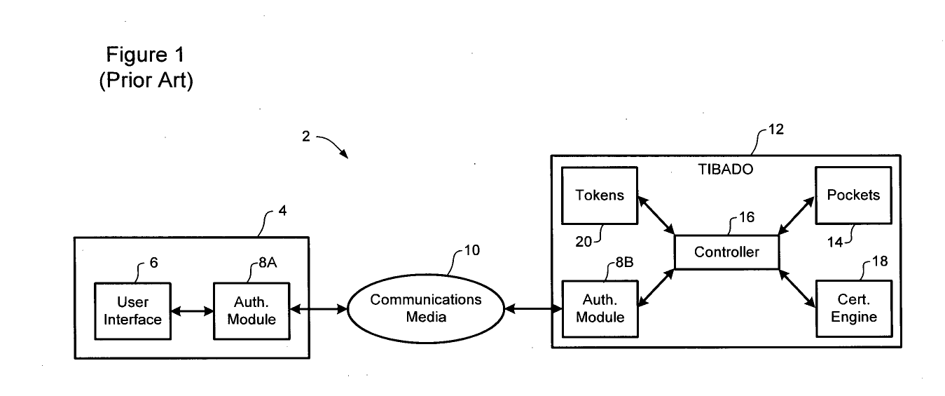

### DETAILED DESCRIPTION

Embodiments of the present invention and their technical advantages may be better understood by referring to the figures. For the purposes of the following description, the present invention is described by way of a representative embodiment in which users of the system create, send, receive and load tokens into their respective pockets. This example assumes that the users are natural persons. However, it will be understood that the present invention is equally capable of operation where either or both of the “users” are automated or semi-automated processes such as bots, software agents or the like.

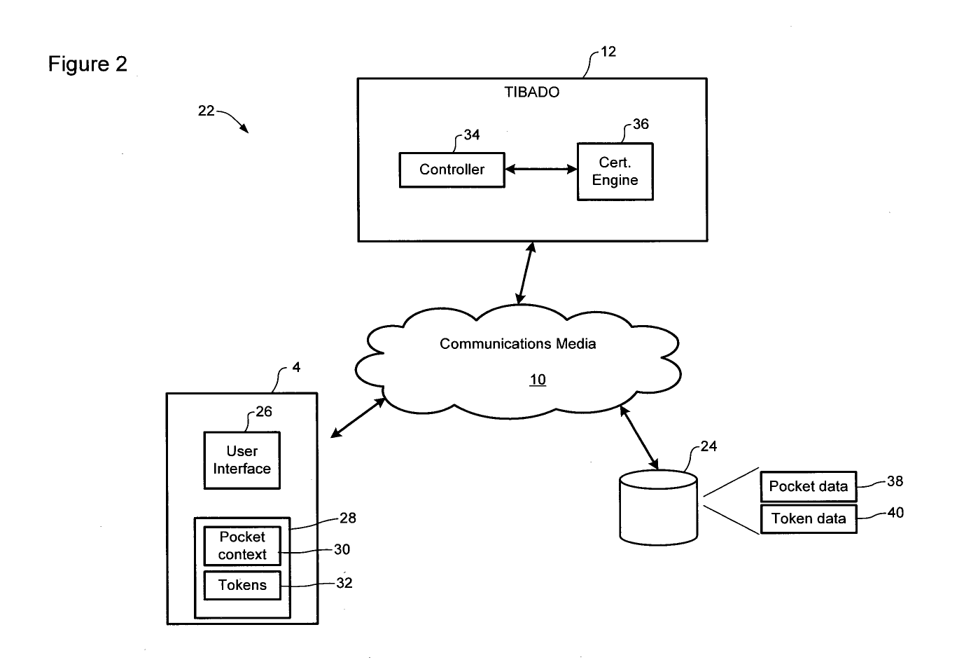

Referring to FIG. 2, a value or rights system 22 of the present invention generally comprises a user's device 4 and a Token Handler 12 connected for communication through a communication medium 10. A validation database 24 connected to the communication medium 10 stores information regarding the current state of the system, as will be described in greater detail below.

The communication medium 10 may comprise any suitable combination of data communications technology capable of enabling data transfer between the user's device 4, pocket controller 12 and the validation database 24. In some embodiments, the communication media 10 may include the internet, but this is not essential. For example, direct device-to-device communication, using, for example, a near-field communications technology such as Bluetooth, may also be supported by the communications media 10. Direct device-to-device communication may be appropriate for transferring tokens between individual users of the system.

The user's device 4 may be provided as any suitable combination of hardware and software capable of supporting a user's interaction with the Token Handler 12, the validation database 24 and other users' devices (not shown in the figures). The user's device 4 may conveniently be provided as any of a mobile phone, a tablet, a PC or the like including, if desired, a special device developed for the purpose. In the illustrated embodiment, the user's device 4 provides a user interface 26 configured to enable the user to interact with the Token Handler 12, the validation database 24 and other users' devices, and a memory 28 configured to store information relating to the user's pocket(s) 30 and any unspent tokens 32.

In some embodiments, a user-installed application software (referred to herein as an App) installed on the user's device 4 may be used to implement the user interface 26 and control communications with at least the Token Handler 12. Such an App may execute within a runtime environment already available on the user's device 4 in accordance with known techniques, and utilize an existing communications interface of the device in order to send and receive data through the communication medium 10. If desired, the App may also implement a User access authentication protocol with the token handler 12, which may be the traditional user name and password or a 2-Factor authentication method using something the user owns such as a smart card and something the user knows such as a password. In some cases, the system may use the Transport Layer Security (TLS) protocol where the user is issued with a client certificate to store in their device 4. If desired, the users' App may enhance this security by requiring further access credentials to use the client certificate such as a user PIN or password. In some cases, it may be useful to consider the App as implementing or instantiating the user's pocket(s).

The pocket information 30 of the user's pocket(s) stored locally in the memory 28 of the user's device 4 may be selected as need to enable the user to manage and control each pocket allocated to them. At a minimum, the information pertaining to each pocket may define a context of the pocket, including a unique identifier of the pocket (pocket ID) and a total value stored in the pocket: Alternatively, the information pertaining to each pocket 30 may comprise further information, in addition to the pocket context. For example, the pocket information may include information identifying a currency in which value stored in the pocket are denominated. In some cases, a pocket may be limited to storing value denominated in a single currency. In other cases, a pocket may be configured to store value denominated in a more than one currency, in which case, the pocket information may include more than one value amount and corresponding currency identifiers. The pocket information may also include a nonce or datestamp or the like, which may identify a time when the value of the stored coins was changed. Alternatively, the nonce or datestamp may be used to identify the most recent version of the pocket information. If desired, the pocket information may also include one or more cryptographic checksums so that authorized changes in at least the pocket context can be readily detected.

In some embodiments, unspent tokens 32 stored in the memory of the user's device 4 may be represented by a unique token identifier (Token ID), a value of the token, and one or more checksums protecting the token. In preferred embodiments, the token is protected by at least two checksums, which may be generated by the Token Handler 12 under respective different security domains, as will be described in greater detail below. In some embodiments, only the token ID and at least one checksum need to be stored in the memory 28 of the user's device, This information is sufficient to positively identify the token and determine its validity, as will be described in greater detail below. If desired, a token may also include an indication of a currency in which the value of the token is denominated.

In some embodiments, it may be useful to consider a token as a “coin” having a user-defined value. In this case, the total value (of any given currency) held in a user's pocket may be defined using a “pocket coin”, and unspent tokens held by the user may be considered to be unspent coins. The format and information content of pocket coins may be identical to unspent coins, so that the primary distinction between the two lies in how they are stored and used by the App executing on the user's device 4. For this reason, it is sometimes appropriate to refer to “coins” without distinguishing between pocket and unspent coins.

The Token Handler 12 may be provided as any suitable combination of hardware and software capable of supporting interaction with multiple user's devices 4 and the validation database 24. In some embodiments, the Token Handler 12 may be provided as one or more computers (including a computer cluster, a network of computers or a virtual server system running in a cloud environment) connected to the communications medium 10. Suitable software stored in a non-transitory storage medium and executing on one or more central processing units of the Token Handler 12 may operate to implement the various functions of the Token Handler 12. In the illustrated embodiment, software executing one or more central processing units of the Token Handler 12 instantiates a controller 34 and a certification engine 36, both of which will be described in greater detail below.

The validation database 24 is configured to securely record information defining the current status of the system. In the illustrated embodiment, the validation database 24 stores pocket data 38 pertaining to pockets associated with users of the system, and token data 40 pertaining to unspent coins. However, this is not essential. For example, it is possible to implement the validation database 24 storing only token data 40, which in this case may include data of both pocket coins and unspent coins. pertaining to unspent coins In some embodiments, the validation database 24 may be co-located with the Token Handler 12, but this is not essential. If desired, the database 24 may be implemented on a server system that is independent of the Token Handler 12. For example, the database 24 may be hosted by a virtual server maintained by a cloud computing service.

If desired, the pocket data 38 may be equivalent to the pocket information 30 stored in the memory 28 of each user's device 4. However, this is not essential. For example, in an embodiment in which the pocket information 30 stored in the memory 28 of user's devices 4 is limited to the pocket context, then the pocket data 38 stored in the validation database 24 preferably contains both the pocket context and additional information (including, for example, currency identifier, nonce or datestamp, and checksum) providing a complete definition of the pocket. On the other hand, in an embodiment in which the pocket information 30 stored in the memory 28 of user's devices 4 provides a more complete definition of the pocket, then the pocket data 38 stored in the validation database 24 can contain comparatively less information. In call cases, however, the pocket data 38 stored in the validation database 24 must contain sufficient information to enable the Token Handler 12 to determine that pocket information 30 presented to it by a user is valid and represents the current state of that pocket. A further feature of the pocket data 38 is that while it contains information identifying each pocket at its current state, nothing in this information identifies the user to whom the pocket is assigned.

Similarly, the token data 40 may be equivalent to the tokens 32 stored in the memory 28 of each user's device 4. However, this is not essential. For example, in an embodiment in which the tokens 32 stored in the memory 28 of user's devices 4 is limited to the token ID and one or more checksums, then the token data 40 stored in the validation database preferably contains token ID as well as additional information (including, for example, a “coin” value of the token, and one or more checksums protecting the token) providing a complete definition of the token. On the other hand, in an embodiment in which the token information 32 stored in the memory 28 of user's devices 4 provides a more complete definition of the token, then the token data 40 stored in the validation database 24 can contain comparatively less information. In call cases, however, the token data 40 stored in the validation database 24 must contain sufficient information to enable the Token Handler 12 to verify that a token 32 presented to it by a user is valid. A further feature of the token data 40 is that while it contains information identifying each token, nothing in this information identifies the user to whom the token is assigned.

If desired, the content of the validation database 24 may be published and so may be read by any party with suitable software, such as, for example the App instantiating the user interface 26 on a user's device 4. It will be appreciated that because the pocket data 38 and token data 40 do not contain information identifying users, anonymity of the users can be protected, even though the content of the database is publicly available.

The validation database 24 preferably includes one or more security features such that any attempt to tamper with the content of the database would be very difficult to accomplish without detection, and even if successful would be readily detectable, and consequently readily detectable. One method of securing the validation database 24 is to configure the database 24 such that only the Token Handler 12 is able to write new data content to the database 24. Some example methods that may be used for this purpose include (without limitation): the database 24 may be implemented with a proprietary Application Program Interface (API) that is used by the Token Handler 12 but is not publicly disclosed; the database 24 may be implemented such that it will execute write commands that are protected by a known password or the like, and will reject any other write commands; and the database 24 may be implemented such that it will execute write commends that are received through a secure connection with the Token Handler 12, and will reject write commands received from any other sources. Other methods may also be used without departing from the intended scope of the present invention.

In addition, the validation database 24 may be protected by one or more cryptographic checksums or hash values, which can be used to detect changes in the database. Those of ordinary skill in the art will recognise that this method of protecting the database 10 is similar to a blockchain as described by Santoshi Nakamoto in Bitcoin: A Peer-to-Peer Electronic Cash System, published November 2008. In the Bitcoin blockchain, transactions received within a given period of time are collected into a block, which is then used to compute a hash value that includes a timestamp and the hash value computed for the previous block. The result is a chain of blocks (or, more correctly, hash values), that can be used to detect and frustrate attempts to tamper with already received transactions. The hash values provide a “proof of work”, which makes it very difficult (but not impossible) for a dishonest operator to subvert the block-chain. It has been proposed that the blockchain as proposed by Nakamoto or a suitable variant thereof could be used to produce a publicly accessible, and yet secure, register of various types of data, not just transaction data. If desired, the validation database 24 may be implemented as a blockchain. However, it will be appreciated that this is not essential.

As noted above, each user who participates in the value token transfer scheme is assigned one or more pockets which store the balance of their “coins”, which may be transferred to and from other users of the system by means of tokens. Each pocket can store the same or a different currency depending on how the pockets were initially defined and assigned to the user.

Users interact with the system through their user interface 26 on their device 4, which is configured to connect through the communications media 10 to the Token Handler 12. This communication path may be cryptographically protected by TLS for example to counteract security vulnerabilities in the communications media 10.

By means of this connection to the token controller 12 the users can securely create or extract and load or insert tokens for the transfer of value or rights.

When the user wants to create a token, they send a request to the controller 34. In accordance with the present invention, the request may include the pocket context of the pocket (or the pocket coin) from which the token is to be created. Alternatively, the controller 34 may query the user (or the App running on the user's device 4) to transmit the pocket context, for example as part of the token creation process. The controller 34 accesses the validation database 24 to determine that the pocket context (or pocket coin) is valid and current, and checks the current total value stored in the pocket, and as long as the balance would remain positive after the transaction it creates a token with the requested value and adds a corresponding token data 40 entry in the database 24 while debiting the balance in the user's pocket by the value of the token. Based on the new balance of the user's pocket, the controller 34 generates an updated pocket context information 30 (or a new pocket coin), and adds corresponding updated pocket data 38 to the database 24

The controller 34 also connects to the certification engine 36 that creates the cryptographic check sums necessary to protect the token (and pocket context or pocket coin, as appropriate). As noted above, the token is preferably protected by two cryptographic check sums created in different security domains. In some embodiments, each cryptographic check sum may be created by a respective different certification engine 36 (for simplicity of illustration, only one Certification Engine 36 is shown in the drawings). In some embodiments, each certification engine 36 may be operated by respective different legal entities. This arrangement improves the security of the system by making it very difficult for a single entity (e.g. a hacker) to be able to create tokens or load value into any pockets. It is anticipated that in many cases the Token Handler 12 may comprise one or more servers in the cloud, and these servers may be managed by a third party. The use of the dual cryptographic check sum avoids the obvious collusion attacks associated with multiple cloud server systems.

Having created the protected token 32 the controller 34 passes both the token 32 and the revised pocket context information 30 (or new pocket coin) back to the user's device 4 by means of the secure channel between the token controller 12 and the user's device 4. The user's App stores both the token 32 and the pocket context information 30 in the memory 28 as appropriate. As noted above, in some embodiments it is only necessary to for the pocket context information 30 stored in the memory 28 of the user's device 4 to include the pocket ID and cryptographic checksum, because the complete token data 40 is stored in the validation database 24.

The user may choose to store this token 32 for an arbitrary period of time at which point they may pass the token 32 to another user (a payee) by any suitable communications means such as email or a messenger application for example. It should be clear that at this point the sending user (the payer) may be off-line from the Token Handler 12 and might pass the token 32 to the payee by some local communication path such as Bluetooth to the receiver.

Depending on the situation and the degree of trust between the participants of the transaction, the payer may choose to send only one of the two cryptographic check sums to the payee with the token 32. With this information the payee can validate the token 32 and associate it with their pocket by connecting to the Token Handler 12 using an authenticated channel through the communications media 10, and then interacting with the controller 34 to execute a load operation.

Upon receipt of the token and (one) check sum, the controller 34 can use the check sum to confirm the validity of the token 32, and use information obtained through the authentication process (or directly from the receiver) to identify a pocket associated with the payee. If the validity check is successful, the controller 34 can change the token's status in the database 24 to mark it as being assigned to the payee's pocket, but will not actually vest the value of the token in the pocket. The token value is not yet available to the payee, and cannot be spent by the payee, until it has been vested in the pocket by the controller 34. Once the controller 34 has successfully confirmed the validity of the token, the payee now knows the token is valid and can complete the transaction with the payer by, for example, the supply of goods and/or services. When the necessary conditions have been met, the payer may send the Verification Certificate (i.e. the second cryptographic check sum) to the payee by any suitable communications method including for example email.

Once the payee has received the Verification Certificate, the payee can now complete the load process by connecting to the pocket server 2 by means of the authenticated channel over the communications media 3, and supplying the Verification Certificate to the controller 34.

The controller 34 can then check the validity of the Verification Certificate, and if it is valid the controller 34 can update the balance of the payee's pocket, mark the token as spent, and store the updated pocket data 38 and token data 40 in the Database 24. The controller 34 may also generate updated pocket context information 30 for the payee, and transmit this information to the payee's device 4.

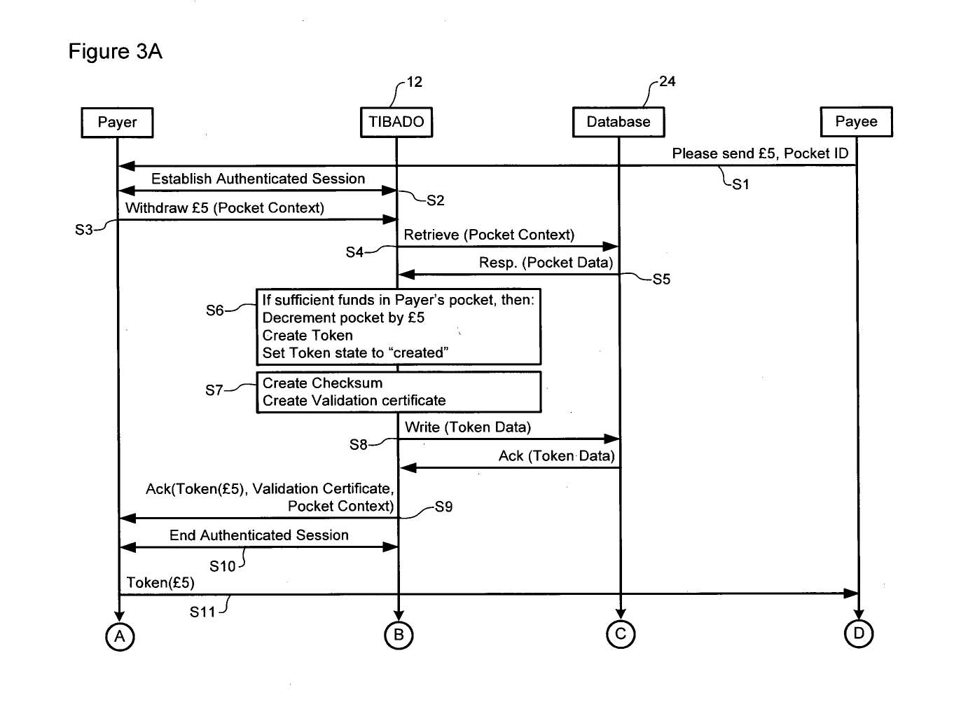

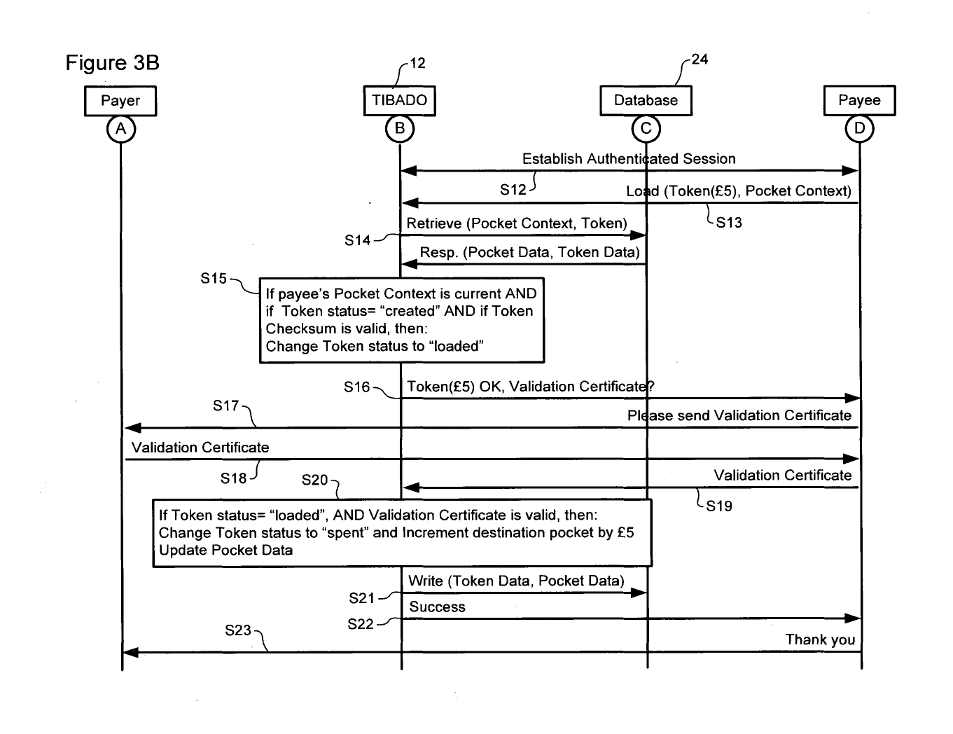

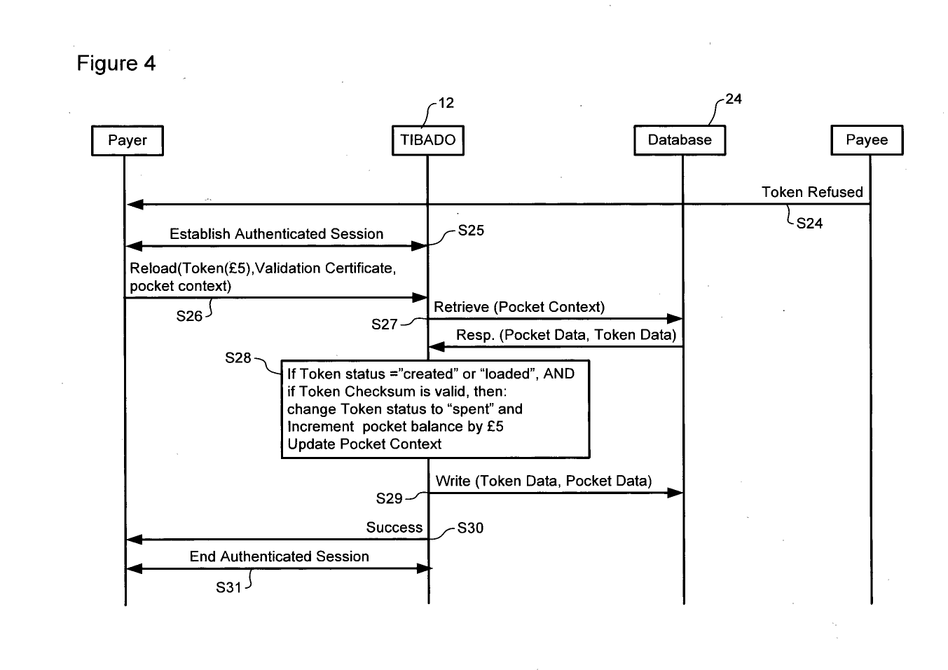

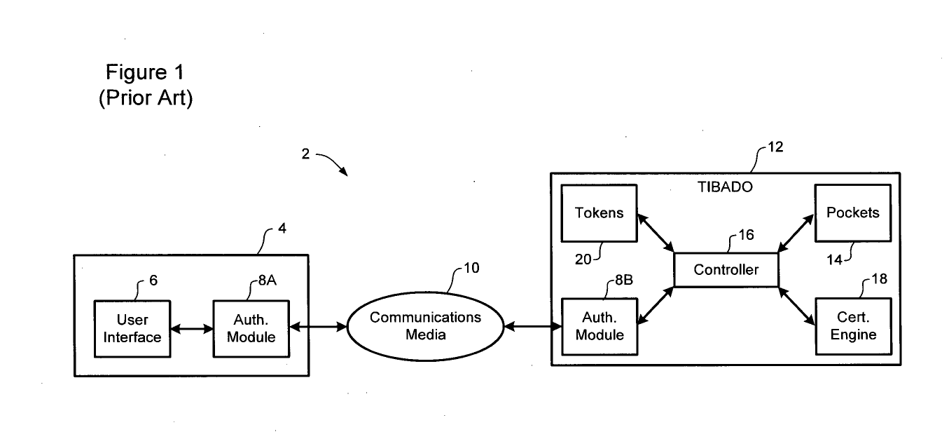

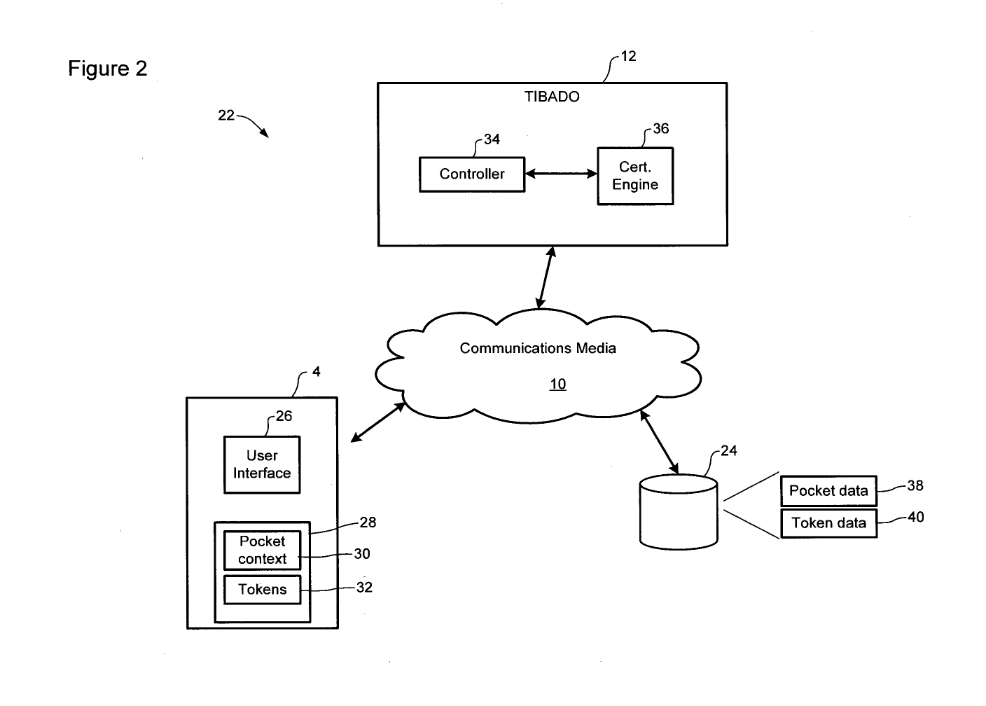

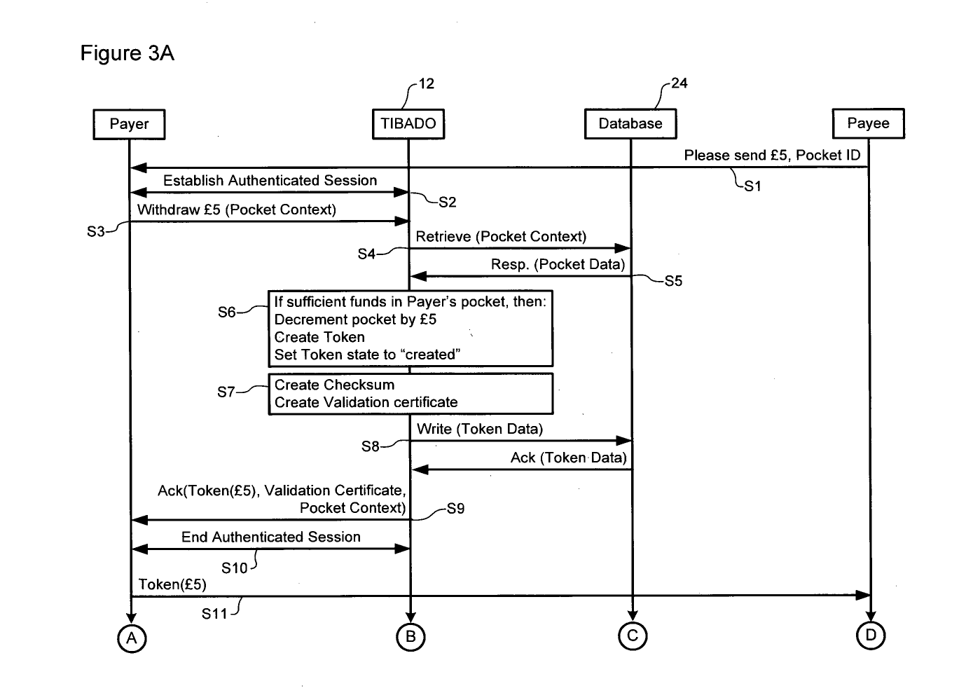

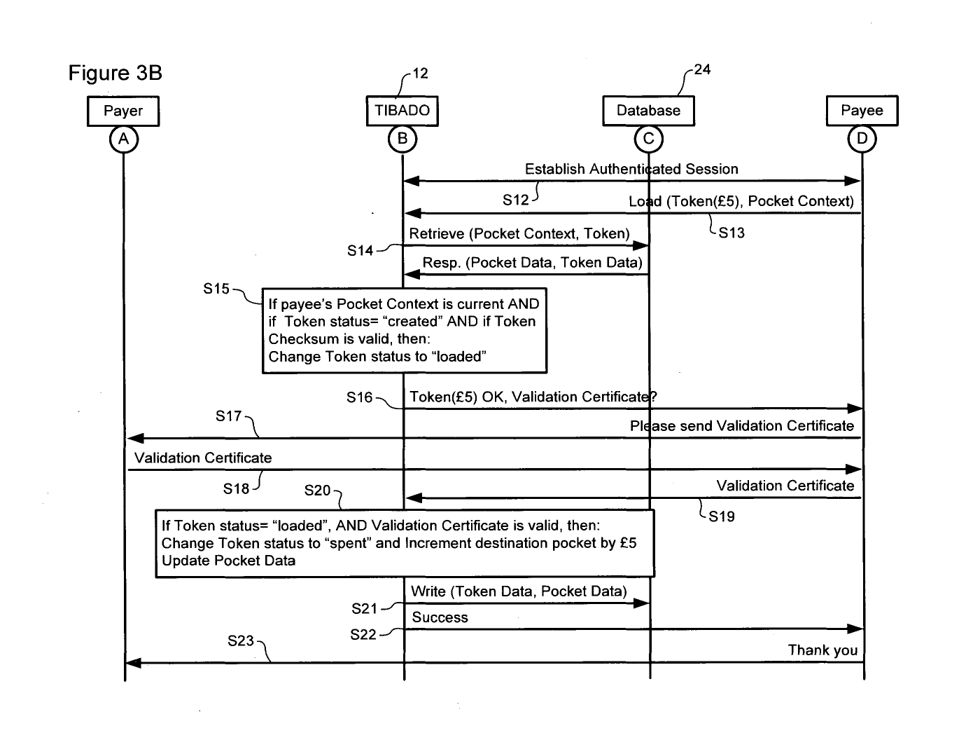

The transaction flow described above can be understood in more detail by referring to the sequence diagram of FIGS. 3A and 3B, in which the term “TIBADO” is an expression used in the drawings that represents the Token Handler 12. In this respect, it will be appreciated that most of the operations attributed to the Token Handler 12 involve the cooperative operation of multiple components including, but not limited to, the controller 34 and certification engine(s) 36.

Referring to FIG. 3A, the process begins at step S1, in which the payee makes a request of the payer for the transfer of a value token for, in this example, £5.

At step S2, the payer establishes an authenticated connection to TIBADO using any suitable method, such as for example using TLS with a client certificate. When the authenticated connection is established the payer makes a request (at step S3) to TIBADO to create a token with a value of £5 and their pocket context information 30

Upon receipt of the request from the payer, TIBADO accesses (at step S4) the Database 24 to retrieve the payer's pocket data, based on the pocket contest information 30 contained in the request, Upon receipt of the payer's pocket data (at step S5) TIBADO checks that the retrieved pocket data represents the latest version of the pocket state (for example by means of a nonce or datestamp contained in the pocket data, and checks (at step S6) the balance of the payer's pocket. If the requested withdrawal would leave a positive (or zero) balance in the payer's pocket, TIBADO decrements the pocket balance by £5, updates the pocket data to reflect the new pocket balance, creates the value token and sets the current state of the token (which at this time is “created”).

If desired, the steps of validating the state of the pocket (i.e. that the retrieved pocket data represents the latest version of the pocket state), checking for sufficient balance in the pocket, creating the token and updating the pocket data may be performed as one or more atomic operations which cannot be interrupted once they have been started. Further, if desired, these steps may be performed by one or more Hardware Security Modules (HSMs) associated with the Token Handler 12. It will be appreciated that the use of atomic operations and HSMs (either alone or in combination) is advantageous in that these steps increase security by reducing the likelihood that a dishonest party might successfully tamper with the creation of new tokens and updating of the pocket data.

TIBADO then connects with the certification engine 36 and generates (at step S7) at least one (and preferably two) cryptographic check sums. In embodiments in which only one cryptographic check sum is generated, the cryptographic check sum may form a Validation Certificate that is associated with the token. In embodiments in which two cryptographic check sum are generated, one of the cryptographic check sums may be embedded within (or attached to) the token, while the other cryptographic check sum forms the Validation Certificate and is normally stored and transmitted separately from the token itself.

TIBADO then stores (at step S8) Token Data about the newly created token and Pocket Data reflecting the updated balance in the database 24. In some embodiments, the token data stored in the database 24 may also include one (or both) of the cryptographic check sums, but this is not essential. Since the controller 34 has exclusive write access to the database 24, it can update the respective states of the user's pocket and the token. It can be seen that the particular property of this centralised database is that only the Token Handler 12 can write to the database 24 whereas other participants have read access only.

At step S9, TIBADO returns the token, its cryptographic check sums and the updated pocket context information to the payer across the authenticated channel.

If desired, once the payer has received the token from TIBADO, the payer may (at step S10) end the authenticated session with TIBADO.

At step S11, the payer sends the token to the payee. In embodiments in which the token is protected by two cryptographic check sums, only one of the cryptographic check sums may be sent to the payee at this time. In other embodiments in which the token is protected by only one cryptographic check sum, then the token may be sent to the payee without the cryptographic check sum.

FIG. 3B illustrates an example, process for loading token value into a user's pocket. In this case, the user is the payee in the example of FIG. 3A.

Referring to FIG. 3B, at step S12, the payee establishes an authenticated connection to TIBADO, for example using TLS with a client certificate, and at step S13 requests the controller 34 to load the token to the payee's pocket. The request will normally include the token and any check sum supplied by the payer, as well as the pocket context information of the payer's pocket into which they wish to load the value of the token.

Upon receipt of the payee's request, TIBADO uses the information contained in the request to retrieve (at step S14) the pocket and token data from the database 24, and checks (at step S15) to determine whether or not: the status of the received token is still “created” (that is, it has not already been “loaded” or “spent” to another destination pocket); that the cryptographic check sum of the token is valid; and that the token context provided by the payer corresponds with the most current state of a pocket associated with the payee. For this purpose, TIBADO may use authentication information obtained during establishment of the authenticated connection to identify pockets and/or pocket groups associated with the payee. If any of these checks fails, TIBADO may reject the load request, and send a corresponding failure message to the payee. Otherwise, TIBADO changes the state of the token to show the status as “loaded”.

Preferably the process of loading the token at step S15 is executed as an atomic operation that it cannot be divided or interrupted during execution. If desired, this operation may be performed by HSMs associated with the Token Handler 12.

At step S16, TIBADO sends a reply to the payee confirming that the token is valid and loaded to the payee's pocket, but the value is not yet vested. The confirmation message may also request the payee to provide the Validation Certificate. If desired, the payee may end the authenticated session with TIBADO following receipt of confirmation that the token is valid.

At step S17, the payee communicates with the payer to request the Validation Certificate for the token that will validate or certify the transaction so that the token value can be vested in the payee's pocket.

At step S18, the payer sends the validation certificate to the payee.

The payee may then establish a new authenticated connection with TIBADO and send (at step S19) the validation certificate to TIBADO. Upon receipt of the validation certificate, TIBADO uses the validation certificate (at step S20) to check the previously received token. If the validation check fails, TIBADO may reject the load request, and send a corresponding failure message to the payee. On the other hand, if the validation check is successful, TIBADO vests the token in the payee's pocket by updating the token data to show the token's new state of “spent”, updating the balance of the payee's pocket by the value of the token, and updating the pocket context information to reflect the new balance. Preferably the process of vesting the Token at step S20 is executed as an atomic database operation, in that it cannot be divided or interrupted during execution.

At step S21, TIBADO writes the updated token data and pocket data of the database 24 to record the new state of the token and the payee's pocket.

At step S22, TIBADO sends a confirmation message to the payee confirming the results of the processing at step S21. In the event that the processing was successful, the confirmation message indicates that the token value (in this case, £5) has been added to the payee's pocket, along with the updated pocket context information relating to the payee's pocket. At step S23, the payee may send a confirmation “thank you” message to the payer indicating that the transaction has been successfully completed.

The token controller 12 may allow the payee a predefined number of attempts to load the token to their pocket, or alternatively may permit an unlimited of attempts. If the number of attempts to load the token is limited, then the token controller 12 must keep a counter to record these events.

It is also possible to allow the original creator of the token to be able to reload the token back into their own pocket. This operation may be used to override a situation in which where the payee cannot successfully load their token into their pocket (for example, the maximum number of load attempts by the payee has been reached). For this purpose, the token controller 12 may keep a record of which pocket was used to create the token.

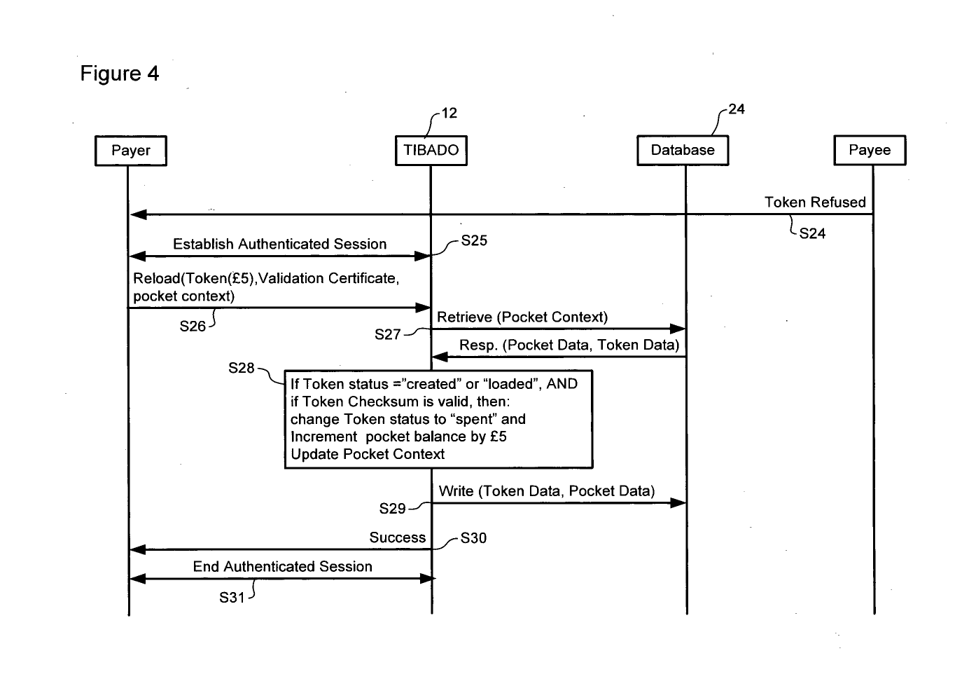

FIG. 4 illustrates an example process for reloading a token in an event in which the payee does not successfully load their token. Referring to FIG. 4, at step S24, the payee sends a message to the payer indicating that they were unable to load their token. Following receipt of the message, the payer may (at step S25), establish an authenticated connection to TIBADO using any suitable method, such as for example using TLS with a client certificate.

When the authenticated connection is established the payer makes a request (at step S26) to TIBADO to reload the token. In some embodiments, the reload request includes at least the token and (optionally) the validation certificate, as well as the pocket context of the payer's pocket into which the token value should be reloaded. Upon receipt of the request, TIBADO uses the pocket context provided in the reload request to access the database 24 and retrieve (at step S27) the pocket data a token data. Based on this information, TIBADO may check the status of the token (at step S28). If the token status is either “created” or “loaded” (that is, the token status is not “spent”), the token checksum is valid, and the Pocket Context represents the most current status of the payer's pocket, then TIBADO can operate to reload the token into the payer's pocket. One method by which this can be done is by updating the token data to show the token's new state of “spent”, updating the balance of the payer's pocket by the value of the token, and updating the pocket context information to reflect the new balance. Preferably the process of vesting the Token at step S28 is executed as an atomic database operation, in that it cannot be divided or interrupted during execution.

At step S29, TIBADO writes the updated token data and pocket data to the database 24 to record the new state of the token and the payee's pocket.

At step S30, TIBADO sends a confirmation message to the confirming the results of the processing at step S28. In the event that the processing was successful, the confirmation message indicates that the token value (in this case, £5) has been added to the payee's pocket, along with the updated pocket context information relating to the payee's pocket.

In the embodiments described above, the payer and payee establish authenticated connections with the Token Handler 12 (see, for example, steps S2, S12 and S24) in order to perform the desired withdrawal and load operations. However, it will be appreciated that in some embodiments, the use of authenticated connections is not essential. For example, in an embodiment in which the validation database 24 stores only date related to pocket coins and unspent coins (i.e. tokens) then it is only necessary for the Token Handler 12 to validate the coins and tokens presented to it by each user.

In the embodiments described above, the Token Handler 12 records information of each transaction in the validation database 24 (steps S8, S21 and S29) before sending acknowledgement messages (steps S9, S22 and S30). If desired, this order of operations may be reversed. For example, the Token Handler 12 may be controlled to send the new tokens, pocket context and/or pocket coins (as appropriate) to the user, and then await confirmation that the user has correctly received these items before recording the token and pocket data in the validation database. This arrangement may be useful as a means of verifying that the user has received the new tokens, pocket context and/or pocket coins before they are recorded in the validation database.

Following completion of the above-noted processing steps, the payer may end (at step S31) the authenticated session with TIBADO.

1. An electronic value transfer system comprising:
validation database configured to store: pocket data defining a current state of a plurality of pockets, each pocket associated with a respective user of the system and storing a value balance owned by the respective user; and token data defining a current state of a plurality of tokens
a controller configured to respond to a withdrawal request message including a value amount and first pocket context information, to perform the steps of:
validate the first pocket context information of the withdrawal request message using the database, wherein validating the first pocket context information comprises verifying whether or not the first pocket context information defines a most recent state of the first pocket;
generate a first token comprising first token data including a unique token identifier and the value amount;
record information of the generated first token in the database, the recorded information of the first token including the token data and a created status of the first token; and
return the generated first token, the cryptographic check sum and updated first pocket context information as a response to the withdrawal request message; and
the controller being further configured to respond to a load request message including a second token, a cryptographic check sum of the second token and second pocket context information to perform the steps of:
validate the second pocket context information of the load request message using the database, wherein validating the second pocket context information comprises verifying whether or not the second pocket context information defines a most recent state of the second pocket;
validate the second token using the database, wherein validating the second token comprises verifying whether or not a status of the second token is “spent”; and
responsive to successful validation of the second pocket context information and the second token, update the recorded token data in the database to identify a spent status of the token, and compute updated second pocket data defining an updated state of the second pocket.

2. The electronic value system as claimed in claim 1 wherein the cryptographic check sum comprises a digital signature.

3. The electronic value system as claimed in claim 1 wherein content of the validation database is publicly accessible.

4. The electronic value system as claimed in claim 1 wherein the validation database is responsive only to the controller to record information.

5. The electronic value system as claimed in claim 1 wherein the pocket data comprises, for each pocket, a unique identifier of the pocket and a total value stored in the pocket.

6. The electronic value system as claimed in claim 1 wherein the pocket data comprises, for each pocket, a pocket coin including a unique identifier of the pocket coin, a value of the pocket coin, and one or more check sums.

7. The electronic value system as claimed in claim 1 wherein the token data comprises, for each token, a unique identifier of the token, a value of the token, and one or more check sums.

8. The electronic value system as claimed in claim 6 wherein the first pocket context information comprises either the respective pocket coin associated with the first pocket or the unique identifier of the pocket coin associated with the first pocket.

9. The electronic value system as claimed in claim 6 wherein the second pocket context information comprises either the respective pocket coin associated with the second pocket or the unique identifier of the pocket coin associated with the second pocket.

10. A non-transitory storage medium storing software instructions configured to control a central processor unit to execute steps of:
receive a withdrawal request message including a value amount and first pocket context information;
validate the first pocket context information of the withdrawal request message using a validation database configured to store: pocket data defining a current state of a plurality of pockets, each pocket associated with a respective user of the system and storing a value balance owned by the respective user; and token data defining a current state of a plurality of tokens, wherein validating the first pocket context information comprises verifying whether or not the first pocket context information defines a most recent state of the first pocket;
generate a first token comprising first token data including a unique token identifier and the value amount;
record information of the generated first token in the database, the recorded information of the first token including the token data and a created status of the first token; and
return the generated first token, the cryptographic check sum and updated first pocket context information as a response to the authenticated.

11. The non-transitory storage medium as claimed in claim 10 further comprising software instructions configured to control the central processor unit to execute steps of:
receive a load request message including a second token, a cryptographic check sum of the second token and second pocket context information;
validate the second pocket context information of the load request message using the database, wherein validating the second pocket context information comprises verifying whether or not the second pocket context information defines a most recent state of the second pocket;
validate the second token using the database, wherein validating the second token comprises verifying whether or not a status of the second token is “spent”; and
responsive to successful validation of the second pocket context information and the second token, update the recorded token data in the database to identify a spent status of the token, and compute updated second pocket data defining an updated state of the second pocket.
